(19) United States
(12) Patent Application Publication
(10) Pub. No.: US 2014/0074449 A1
(43) Pub. Date: Mar. 13, 2014

(54) SCALABLE POWER MODEL CALIBRATION

(71) Applicants: Mark F. Turner, Longmont, CO (US); Jonathan W. Byrn, Fort Collins, CO (US); Robert F. Kalinowski, Erie, CO (US); Paul R. Crellin, Boulder, CO (US)

(72) Inventors: Mark F. Turner, Longmont, CO (US); Jonathan W. Byrn, Fort Collins, CO (US); Robert F. Kalinowski, Erie, CO (US); Paul R. Crellin, Boulder, CO (US)

(73) Assignee: LSI CORPORATION, Milpitas, CA (US)

(21) Appl. No.: 13/607,151

(22) Filed: Sep. 7, 2012

(51) Int. Cl. G06F 17/50

(52) U.S. Cl. 703/14

(57) ABSTRACT

A high-frequency supply voltage waveform is sampled from a functioning integrated circuit. This waveform is measured at (or coupled closely to) a power supply node on the integrated circuit. A low-frequency supply current waveform is sampled concurrently with the sampling the high-frequency supply voltage waveform. This waveform is measured at a power supply node external to the integrated circuit. A power supply network providing power to the integrated circuit is modeled with a circuit model. The power supply network is modeled using the high-frequency supply voltage waveform as an input to the circuit model. A simulation output is taken at a simulated power supply node corresponding to the power supply node external to said integrated circuit. Based on a comparison of the simulated low-frequency supply current waveform and the low-frequency supply current waveform, a value of at least one component of the circuit model is adjusted.

### BACKGROUND OF THE INVENTION

CMOS IC's consume power from the system power supply. The power supply needs to be designed robustly so that it provides a stable voltage under a wide range of current. However, the IC's typically do not present a static unchanging load to the power supply. Rather, they present a varying load which can draw a wide range of current from the power supply. Usually CMOS IC's are specified by the maximum current they can draw (Iₘₐₓ). Since power is the product of current and voltage (P=IV), and the voltage is typically considered to be a constant value (assuming the power supply is ideal), then an IC's power and current may be discussed interchangeably. Most power supplies are designed with an assumed worst case condition of having to provide Iₘₐₓ continuously. However, in reality as the IC transitions from idle to busy calculations and back to idle, it transitions from drawing very little current (possibly approaching 0), to Iₘₐₓ, and then back to very little current. Also, the maximum current may change under different performance operating conditions. For example, many IC's (including those currently being designed for hard disk storage) may operate at different clock speeds while in operation. This presents different power demands according to the switching power equation P=CV²F.

Transitions in current draw may present problems in the IC because the package pin has significant inductance. The equation V=L*di/dt can be used to illustrate how much difference the power supply (e.g., VDD) voltage level will be inside the chip as compared to the power supply on the printed circuit board (PCB) power supply with a large di/dt (i.e., during a current transition). As an example, consider a case where VDD is 1V on the PCB, and an IC is transitioning from 0 A to 1 A current draw in 5 nS. Also, the package has, for example, 1 nH of pin inductance. Without accounting for helpful capacitance on the die, this above equation would suggest that the voltage drop across the package pin would be V=L*di/dt=1 nH*(⅕ nS)=⅕ V or 200 mV. That means that in this example the on-die voltage may drop to 0.8V with this current transient. In reality the on-die capacitance helps stabilize the voltage, but understanding the current transients of an IC is desired to accurately specify the system power supply. An IC will fail in operation if its on-die VDD supply gets too low.

### SUMMARY OF THE INVENTION

An embodiment of the invention may therefore comprise a method of modeling a power supply network, comprising: sampling a high-frequency supply voltage waveform, said high-frequency supply voltage waveform measured at a power supply node on an integrated circuit; sampling a low-frequency supply current waveform concurrently with said sampling said high-frequency supply voltage waveform, said low-frequency supply current waveform measured at a power supply node external to said integrated circuit, said power supply network connecting said power supply node on said integrated circuit and said power supply node external to said integrated circuit; modeling said power supply network with a circuit model having a plurality of components; simulating said power supply network using said high-frequency supply voltage waveform as an input to said circuit model, a simulation output including a simulated low-frequency supply current waveform, said simulated low-frequency supply current waveform taken at a simulated power supply node corresponding to said power supply node external to said integrated circuit; and, based on a comparison of said simulated low-frequency supply current waveform and said low-frequency supply current waveform, adjusting a value of at least one of said plurality of components.

An embodiment of the invention may therefore further comprise an apparatus for modeling a power supply network, comprising: a sampler configured to sample a high-frequency supply voltage waveform at a power supply node on an integrated circuit and to concurrently sample a low-frequency supply current waveform at a power supply node external to said integrated circuit, said power supply network connecting said power supply node on said integrated circuit and said power supply node external to said integrated circuit; a simulator configured to simulate said power supply network using said high-frequency supply voltage waveform as an input to a circuit model, a simulation output including a simulated low-frequency supply current waveform, said simulated low-frequency supply current waveform taken at a simulated power supply node corresponding to said power supply node external to said integrated circuit; a modeler to, based on a comparison of said simulated low-frequency supply current waveform and said low-frequency supply current waveform, adjust a value of at least one of a plurality of components used in said circuit model.

### BRIEF DESCRIPTION OF THE DRAWINGS

FIG. 1 is a block diagram of a system for sampling power supply waveforms.

FIG. 2 is a block diagram of a system for modeling power supply networks.

FIG. 3 is a flowchart of a method of modeling a power supply network.

FIG. 4 is a flowchart of a method of modeling a power supply network.

FIG. 5 is a block diagram of a computer system.

### DETAILED DESCRIPTION OF THE EMBODIMENTS

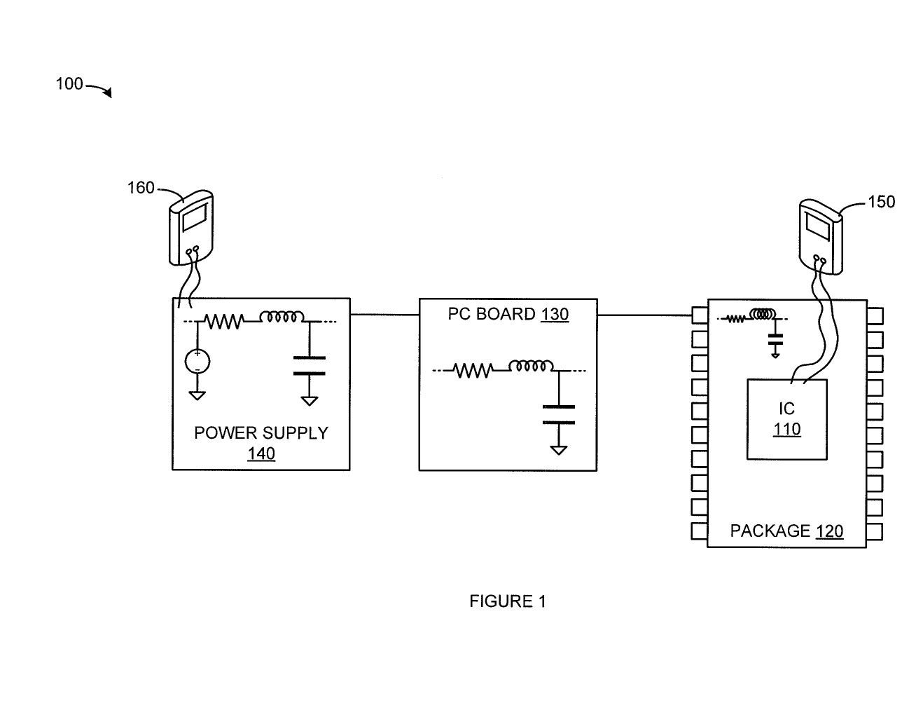

FIG. 1 is a block diagram of a system for sampling power supply waveforms. In FIG. 1, system 100 includes power supply 140, printed circuit board (PCB) 130, integrated circuit package 120, sampler 150, and sampler 160. Integrated circuit package 110 contains integrated circuit (IC) 110. Power supply 140 is operatively coupled to IC 110 via PCB 130 and package 120 to supply power to IC 110. Power supply 140 is shown having a voltage source and parasitic resistance, inductance, and capacitance. PCB 130 is shown having parasitic resistance, inductance, and capacitance. Package 120 is shown having parasitic resistance, inductance, and capacitance. It should be understood that collectively, the parasitic resistances, inductances, and capacitances of power supply 140, PCB 130, and package 120 form a power supply network that supplies power to IC 110.

Sampler 160 is operatively coupled to power supply 140 (or a component thereof) to sample a supply current waveform (i.e., a waveform of the current being supplied by power supply 140). Sampler 150 is operatively coupled to IC 110 to sample a supply voltage waveform (i.e., a waveform of the voltage of a power supply node on IC 110). In an embodiment, sampler 160 samples a low-frequency supply current waveform. In an embodiment, sampler 150 samples a high-frequency voltage waveform. Sampler 150 and sampler 160 may sample their respective waveforms concurrently while IC 110 is in operation.

Sampler 150 may measure the high-frequency voltage waveform at a probe landing on IC 110 that is electrically connected to a power supply node of IC 110. Sampler 150 may measure the high-frequency voltage waveform at a power supply lead of package 120 that has been electrically disconnected (e.g., “lifted”) from PCB 130.

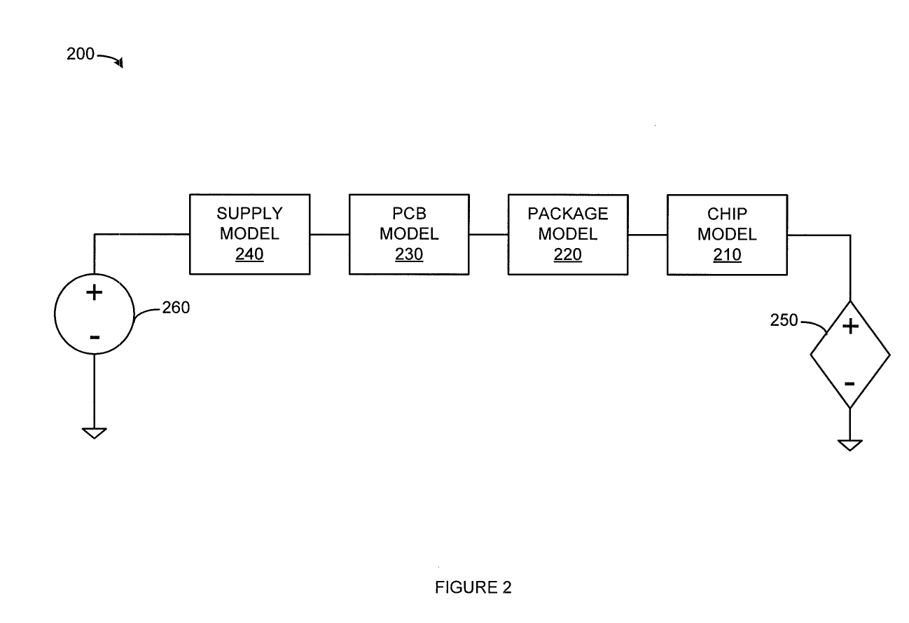

FIG. 2 is a block diagram of a system for modeling power supply networks. Model 200 comprises chip model 210, package model 220, PCB model 230, supply model 240, variable voltage source 250, and voltage source 260. Voltage source 260 is set to correspond to the voltage being supplied by power supply 140. Voltage source 260 is coupled to variable voltage source 250 via, in order, supply model 240, PCB model 230, package model 220, and chip model 210.

Supply model 240 has resistance(s), capacitance(s), and/or inductance(s) to model the parasitic properties of power supply 140. PCB model 230 has resistance(s), capacitance(s), and/or inductance(s) to model the parasitic properties of PCB 130. Package model 220 has resistance(s), capacitance(s), and/or inductance(s) to model the parasitic properties of package 220. Chip model 210 has resistance(s), capacitance(s), and/or inductance(s) to model the parasitic properties of IC 110. One or more of the resistance(s), capacitance(s), and/or inductance(s) of supply model 240, PCB model 230, package model 220, and/or chip model 210 may be selected based on a resonant frequency that appears in the high-frequency voltage waveform sampled by sampler 150.

In an embodiment, during a simulation (i.e., a computer simulation using SPICE or other electronic design simulation tool), variable voltage source 250 is set to reproduce the high-frequency waveform sampled by sampler 150. Voltage source 260 is set to the constant voltage being supplied by power supply 140 while sampler 150 and sampler 160 were concurrently sampling their respective waveform. An output of this simulation is a simulated low-frequency supply current waveform based on the modeled current through voltage source 260 during the simulation. The simulated low-frequency supply current waveform is compared to the sampled low-frequency supply current sampled by sampler 160. Based on this comparison, one or more elements of supply model 240, PCB model 230, package model 220, and/or chip model 210 are adjusted.

The one or more elements of supply model 240, PCB model 230, package model 220, and/or chip model 210 are adjusted to better match the simulated low-frequency supply current waveform to the sampled low-frequency supply current sampled by sampler 160. In other words, elements of model 200 are adjusted to better match the simulated low-frequency supply current waveform to the sampled low-frequency supply current sampled by sampler 160. The better the match between the simulated low-frequency supply current waveform to the sampled low-frequency supply current sampled by sampler 160, the better model 200 is at modeling the power supply network of system 100. In addition, based on the comparison of the simulated low-frequency supply current waveform and the sampled low-frequency supply current sampled by sampler 160, one or more elements may be added to supply model 240, PCB model 230, package model 220, and/or chip model 210. The process of adjusting (or adding) one or more components, simulating, and comparing the simulated waveform to the sampled waveform may be iteratively repeated to improve model 200.

Since voltage (i.e., high-frequency voltage waveform measured by sampler 150) is easier to measure to a high degree of accuracy in the lab than current, the simulation solves for what current would be required to give that voltage waveform. This is difficult to do mathematically by hand because even with the most simple package and die model involves solving second order differential equations on the discrete data values from sampler 150 voltage measurements. In an embodiment, a circuit simulator is used to solve the current required from power supply 140 (as modeled by voltage source 260). Circuit simulators like Hspice, Pspice, LTspice, Spectre, Eldo, etc.) allow a variable voltage source (e.g., voltage source 250) to be set by a tabular data file to apply time varying voltages. When the simulator set voltage source 250 to reproduce the lab measured data (from sampler 150) as its time varying voltage input, and the electrical model 200 of the IC 110 (i.e., chip model 210), its package 120 (i.e., package model 220), and PCB 130 (i.e., PCB model 230) is connected to voltage source 250, then the current through voltage source 260 can be extracted from the simulation (and saved to a data file). The current through voltage source 260 represents the current required to create the voltage waveform sampled by sampler 150.

The electrical model 200 can be relatively easy to calibrate if it is simple. The simple model 200 can be used for checking calibration as more complex electrical models 200 are substituted in for the chip model 210, package model 220, PCB model 230, and/or supply model 240. Model 200 can be better understood, for example, in terms of three components: PCB model 230 and supply model 240 (which include many discrete components along with the regulator on the power delivery network); package model 220 (which can be modeled with a single lumped package resistance—R_{pkg}—and pin inductance—Lₚᵢₙ); and the chip model 210 (which can be modeled as a single lumped die capacitance—C_{die}—and the time varying voltage source 250—V_{demand}).

PCB model 230 and supply model 240 can be developed from schematics of power supply 140 and system 100. If schematics are not used, a simple PCB model 230 and simple supply model 240 of can be built using an ideal DC voltage source, resistance and inductance in series with the DC voltage source, and a lumped bulk (or bypass) capacitance. The values of the resistance, inductance, and capacitance may be developed using laboratory measurements of system 100. The package pin resistance and inductance (R_{pkg} and L_{pkg}) of package model 220 can be developed through software modeling, through lab measurements of resonant frequencies and voltage drop, or through physical dimensions. The die capacitance (C_{die}) of chip model 210 can be developed using the die area, or through software modeling. Chip model 210 may also have some series resistance (R_{die}) due to the power network on-die. R_{die} may be developed in similar ways.

As discussed herein, using electrical model 200 to simulate system 100 with the V_{demand} time varying waveform as an input and observing the current flowing through the V_{demand} voltage source allows the derivation of the demand current I_{demand}. The initial model 200 can be calibrated by comparing the average currents in different operating modes to the lab measured bench currents. Once a simple model 200 is calibrated, further more sophisticated models 200 can be substituted and calibrated against the simple model 200 as needed. Once I_{demand} is derived at each iteration of model 200, I_{demand} can be directly compared by substituting a current source for voltage source 250 source and running the circuit simulation. This allows the comparison of the voltage in the simulation using I_{demand} current against the voltage sampled by sampler 150 and/or sampler 160 from the original lab measurements.

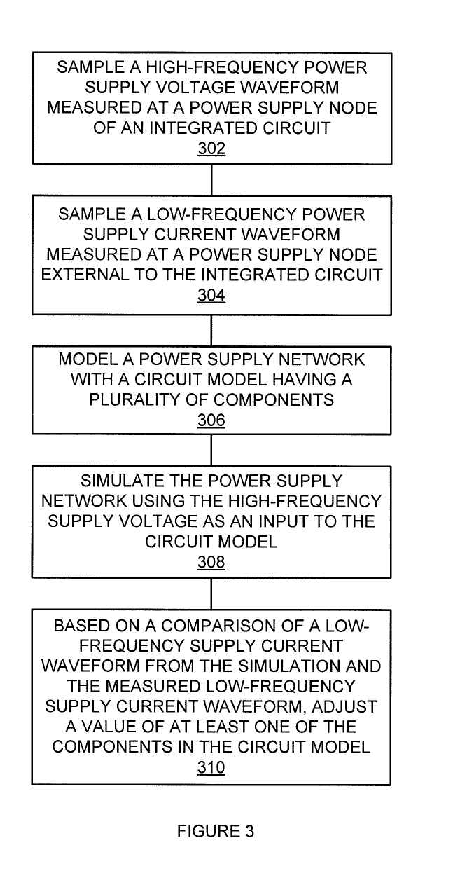

FIG. 3 is a flowchart of a method of modeling a power supply network. The steps illustrated in FIG. 3 may be performed using one or more elements of system 100 and/or model 200. A high-frequency power supply voltage is sampled by measuring at a power supply node of an integrated circuit (302). For example, sampler 150 may measure a high-frequency time sequence of voltages at a power supply node of IC 110. A low-frequency power supply current waveform is sampled by measuring at a power supply node external to the integrated circuit (304). For example, concurrently with sampler 150, sampler 250 may measure a low-frequency time sequence of current (or indicators of current such as a voltage across a known resistance) measurements at a location external to IC 110.

A power supply network is modeled with a circuit model having a plurality of components (306). For example, the power supply network of system 100 may be modeled by model 200 which has a plurality of components (i.e., the elements of supply model 240, PCB model 230, package model 220, and/or chip model 210). The power supply network is simulated using the high-frequency supply voltage as an input to the circuit model (308). For example, the power supply network of system 100 may be simulated using model 200 by controlling voltage source 250 to produce the same voltage waveform as was sampled by sampler 150.

Based on a comparison of a low-frequency supply current waveform from the simulation and the measured low-frequency supply current waveform, a value of at least one of the components in the circuit model is adjusted (310). For example, based on comparison of a low-frequency (or low-pass filtered) supply current waveform taken from voltage source 260 during the simulation using model 200 and the waveform sampled by sampler 160, one or more elements of model 200 (i.e., elements of supply model 240, PCB model 230, package model 220, and/or chip model 210) may be adjusted. The elements of model 200 may be iteratively adjusted to better match the low-frequency (or low-pass filtered) supply current waveform taken from voltage source 260 during the simulation using model 200 and the waveform sampled by sampler 160.

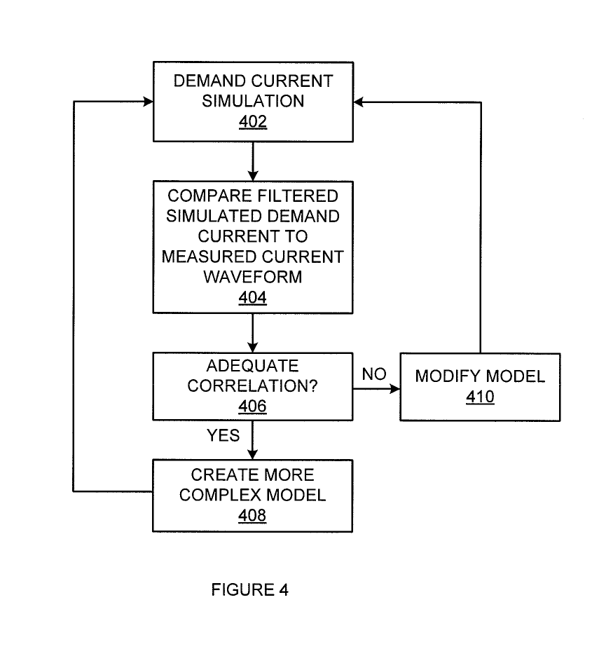

FIG. 4 is a flowchart of a method of modeling a power supply network. The steps illustrated in FIG. 4 may be performed using one or more elements of system 100 and/or model 200. A demand current is simulated (402). For example, For example, the power supply network of system 100 may be simulated using model 200 by controlling voltage source 250 to produce the same voltage waveform as was sampled by sampler 150 and the simulated current through voltage source 250 and/or voltage source 260 may be determined (and stored). The filtered simulated demand current is compared to a measured current waveform (404). For example, the simulated current through voltage source 250 and/or voltage source 260 may be compared to a measured current flowing from power supply 140 (i.e., a current measured by sampler 160).

It is determined whether there was adequate correlation between the filtered simulated demand current and the measured current waveform (406). If there is adequate correlation between the filtered simulated demand current and the measured current waveform, flow proceeds to box 408. If there is not adequate correlation between the filtered simulated demand current and the measured current waveform, flow proceeds to box 410.

If there is not adequate correlation between the filtered simulated demand current and the measured current waveform, one or more elements of the model are modified (410). After the one or more elements of the model are modified, flow proceeds to box 402. If there is adequate correlation between the filtered simulated demand current and the measured current waveform, a more complex model is created (408). After a more complex model is created, flow proceeds to box 402.

The systems described above may be implemented with or executed by one or more computer systems. The methods described above may also be stored on a computer readable medium. Many of the elements of a computer, other electronic system, or integrated circuit, may be created using the methods described above.

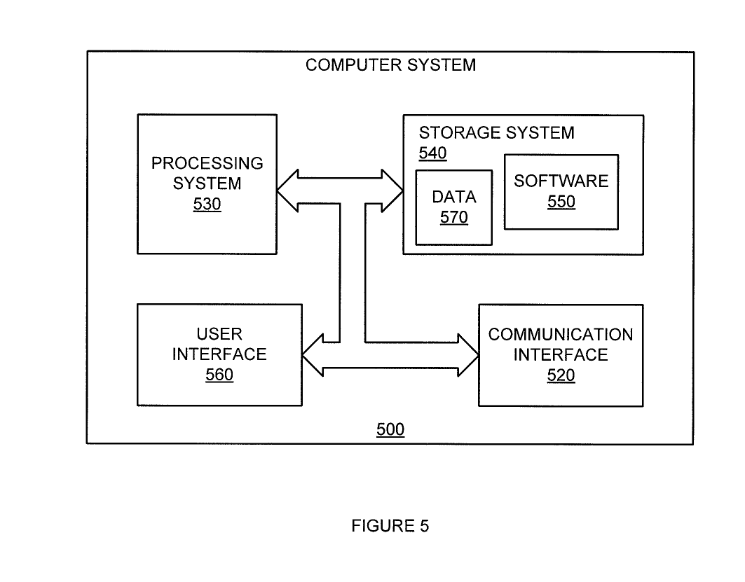

FIG. 5 illustrates a block diagram of a computer system. Computer system 500 includes communication interface 520, processing system 530, storage system 540, and user interface 560. Processing system 530 is operatively coupled to storage system 540. Storage system 540 stores software 550 and data 570. Processing system 530 is operatively coupled to communication interface 520 and user interface 560. Computer system 500 may comprise a programmed general-purpose computer. Computer system 500 may include a microprocessor. Computer system 500 may comprise programmable or special purpose circuitry. Computer system 500 may be distributed among multiple devices, processors, storage, and/or interfaces that together comprise elements 520-570.

Communication interface 520 may comprise a network interface, modem, port, bus, link, transceiver, or other communication device. Communication interface 520 may be distributed among multiple communication devices. Processing system 530 may comprise a microprocessor, microcontroller, logic circuit, or other processing device. Processing system 530 may be distributed among multiple processing devices. User interface 560 may comprise a keyboard, mouse, voice recognition interface, microphone and speakers, graphical display, touch screen, or other type of user interface device. User interface 560 may be distributed among multiple interface devices. Storage system 540 may comprise a disk, tape, integrated circuit, RAM, ROM, network storage, server, or other memory function. Storage system 540 may be a computer readable medium. Storage system 540 may be distributed among multiple memory devices.

Processing system 530 retrieves and executes software 550 from storage system 540. Processing system 530 may retrieve and store data 570. Processing system 530 may also retrieve and store data via communication interface 520. Processing system 530 may create or modify software 550 or data 570 to achieve a tangible result. Processing system 530 may control communication interface 520 or user interface 560 to achieve a tangible result. Processing system 530 may retrieve and execute remotely stored software via communication interface 520.

Software 550 and remotely stored software may comprise an operating system, utilities, drivers, networking software, and other software typically executed by a computer system. Software 550 may comprise an application program, applet, firmware, or other form of machine-readable processing instructions typically executed by a computer system. When executed by processing system 530, software 550 or remotely stored software may direct computer system 500 to operate as described herein.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method of modeling a power supply network, comprising:
sampling a high-frequency supply voltage waveform, said high-frequency supply voltage waveform measured at a power supply node on an integrated circuit;
sampling a low-frequency supply current waveform concurrently with said sampling said high-frequency supply voltage waveform, said low-frequency supply current waveform measured at a power supply node external to said integrated circuit, said power supply network connecting said power supply node on said integrated circuit and said power supply node external to said integrated circuit;
modeling said power supply network with a circuit model having a plurality of components;
simulating said power supply network using said high-frequency supply voltage waveform as an input to said circuit model, a simulation output including a simulated low-frequency supply current waveform, said simulated low-frequency supply current waveform taken at a simulated power supply node corresponding to said power supply node external to said integrated circuit; and,
based on a comparison of said simulated low-frequency supply current waveform and said low-frequency supply current waveform, adjusting a value of at least one of said plurality of components.

2. The method of claim 1, further comprising:
based on said comparison of said simulated low-frequency supply current waveform and said low-frequency supply current waveform, adding a component to said plurality of components.

3. The method of claim 1, further comprising:
iteratively simulating said power supply network using said high-frequency supply voltage waveform as said input to said circuit model and adjusting said value of said at least one of said plurality of components based on said comparison of said simulated low-frequency supply current waveform and said low-frequency supply current waveform.

4. The method of claim 1, wherein said high-frequency supply voltage waveform is measured at probe landing electrically connected to said power supply node on an integrated circuit.

5. The method of claim 1, wherein said high-frequency supply voltage waveform is measured at a power supply lead of a package of said integrated circuit that is not affixed to a printed circuit board.

6. The method of claim 1, wherein said value of at least one of said plurality of components is selected based on a resonant frequency that appears in said high-frequency supply voltage waveform.

7. An apparatus for modeling a power supply network, comprising:
a sampler configured to sample a high-frequency supply voltage waveform at a power supply node on an integrated circuit and to concurrently sample a low-frequency supply current waveform at a power supply node external to said integrated circuit, said power supply network connecting said power supply node on said integrated circuit and said power supply node external to said integrated circuit;
a simulator configured to simulate said power supply network using said high-frequency supply voltage waveform as an input to a circuit model, a simulation output including a simulated low-frequency supply current waveform, said simulated low-frequency supply current waveform taken at a simulated power supply node corresponding to said power supply node external to said integrated circuit;
a modeler to, based on a comparison of said simulated low-frequency supply current waveform and said low-frequency supply current waveform, adjust a value of at least one of a plurality of components used in said circuit model.

8. The apparatus of claim 7, wherein, based on said comparison of said simulated low-frequency supply current waveform and said low-frequency supply current waveform, said modeler adds a component to said plurality of components.

9. The apparatus of claim 7, wherein said power supply network is iteratively simulated using said high-frequency supply voltage waveform as said input to said circuit model and said value of said at least one of said plurality of components is adjusted based on said comparison of said simulated low-frequency supply current waveform and said low-frequency supply current waveform.

10. The apparatus of claim 7, wherein said high-frequency supply voltage waveform is measured at probe landing electrically connected to said power supply node on an integrated circuit.

11. The apparatus of claim 7, wherein said high-frequency supply voltage waveform is measured at a power supply lead of a package of said integrated circuit that is not affixed to a printed circuit board.

12. The apparatus of claim 7, wherein said value of at least one of said plurality of components is selected based on a resonant frequency that appears in said high-frequency supply voltage waveform.

13. A non-transitory computer readable medium having instructions stored thereon for modeling a power supply network that, when executed by a computer, at least instruct the computer to:
receive a sampled high-frequency supply voltage waveform, said sampled high-frequency supply voltage waveform sampled at a power supply node on an integrated circuit;
receive a sampled low-frequency supply current waveform, said sampled low-frequency supply current waveform sampled concurrently with said sampled high-frequency supply voltage waveform, said sampled low-frequency supply current waveform sampled at a power supply node external to said integrated circuit, said power supply network connecting said power supply node on said integrated circuit and said power supply node external to said integrated circuit;
model said power supply network with a circuit model having a plurality of components;
simulate said power supply network using said sampled high-frequency supply voltage waveform as an input to said circuit model, a simulation output including a simulated low-frequency supply current waveform, said simulated low-frequency supply current waveform taken at a simulated power supply node corresponding to said power supply node external to said integrated circuit; and,
based on a comparison of said simulated low-frequency supply current waveform and said sampled low-frequency supply current waveform, adjusting a value of at least one of said plurality of components.

14. The non-transitory computer readable medium of claim 13, wherein the computer is further instructed to:
based on said comparison of said simulated low-frequency supply current waveform and said sampled low-frequency supply current waveform, add a component to said plurality of components.

15. The non-transitory computer readable medium of claim 13, wherein the computer is further instructed to:
iteratively simulate said power supply network using said sampled high-frequency supply voltage waveform as said input to said circuit model and adjust said value of said at least one of said plurality of components based on said comparison of said simulated low-frequency supply current waveform and said sampled low-frequency supply current waveform.

16. The non-transitory computer readable medium of claim 13, wherein said sampled high-frequency supply voltage waveform is measured at probe landing electrically connected to said power supply node on an integrated circuit.

17. The non-transitory computer readable medium of claim 13, wherein said sampled high-frequency supply voltage waveform is measured at a power supply lead of a package of said integrated circuit that is not affixed to a printed circuit board.

18. The non-transitory computer readable medium of claim 13, wherein said value of at least one of said plurality of components is selected based on a resonant frequency that appears in said sampled high-frequency supply voltage waveform.
